(19) United States
(12) Patent Application Publication
(10) Pub. No.: US 2022/0284693 A1
(43) Pub. Date: Sep. 8, 2022

(54) METHOD, APPARATUS AND COMPUTER PROGRAM PRODUCT FOR MANAGING IDENTIFIED ISSUES

(71) Applicant: THE BOEING COMPANY, Chicago, IL (US)

(72) Inventors: Tad W. KELLOGG, Bellevue, WA (US); Michael J. Marich, Seal Beach, CA (US); Rahul C. Thakkar, Leesburg, VA (US)

(21) Appl. No.: 17/652,127

(22) Filed: Feb. 23, 2022

Related U.S. Application Data
(60) Provisional application No. 63/200,413, filed on Mar. 5, 2021.

(51) Int. Cl. G06V 10/74; G06T 7/80; G06T 7/00; G06V 10/24; G06T 17/05

(52) U.S. Cl. CPC G06V 10/74; G06T 7/80; G06T 7/0004; G06V 10/24; G06T 17/05; G06V 2201/07; G06T 2207/30244

(57) ABSTRACT

Embodiments described herein may provide a method for reporting, tracking, and managing resolution of issues. Methods may include: receiving at least one image in which a new issue is identified; receiving information relating to the new issue identified in the at least one image; determining a location of the new issue; identifying any existing issues corresponding to the new issue; generating a severity rating corresponding to the new issue; logging the new issue in a database stored in a memory, where logging the new issue in the database includes adding the new issue to an existing issue in response to the new issue corresponding to the existing issue, and logging the new issue in the database includes generating a new issue entry in the database in response to the new issue failing to correspond to an existing issue; and providing the new issue to a service provider for the service provider to resolve.

### CROSS-REFERENCE TO RELATED APPLICATIONS

This application claims priority to U.S. Provisional Patent Application No. 63/200,413 filed on Mar. 5, 2021, the contents of which are hereby incorporated by reference in their entirety.

### TECHNOLOGICAL FIELD

An example embodiment of the present invention relates generally to a method, apparatus, and computer program product for managing issues in an environment, and more particularly, to providing a method, apparatus, and computer program product for reporting, tracking, and managing resolution of issues within an environment.

### BACKGROUND

Objects and systems generally have a planned or anticipated lifespan. Well-planned maintenance of objects and systems, whether part of the public infrastructure or privately maintained, includes a plan to update or replace objects or systems as they age. The determination of a lifespan of an object or system is generally made by the architects, engineers, and designers of such objects and systems that have experience and historical data from which lifespans can be estimated. Environmental conditions and other localized factors can influence the lifespan of an object or system. For example, a metal structure situated close to a coastline and exposed to salt from the ocean water may have a shorter lifespan than a similar structure in an arid climate away from the ocean. These conditions are often planned for; however, highly localized phenomena can dramatically affect the lifespan of an object or system. Further, events can affect the lifespan of an object or system. Events such as earthquakes, floods, unintended impacts, etc. can dramatically shorten the lifespan of an object or system. Still further, variation in materials used for an object or system may affect the lifespan of the object or system in ways not planned or prepared for.

Due to the variability in lifespans and the external forces that can influence the lifespan and deterioration of objects and systems, periodic inspections are often performed of all kinds of objects and systems to study their condition and to determine if the planned lifespan needs adjustment. As objects and systems are ubiquitous and numerous, periodic inspection of these objects and systems requires substantial cost and labor. Further, periodic inspections may not be frequent enough to capture all issues that may arise with the condition of an object or system. Objects and systems may benefit from more frequent inspection at shorter time intervals; however, the cost to do such inspections may be prohibitive.

### BRIEF SUMMARY

A method, apparatus, and computer program product are therefore provided for providing a method, apparatus, and computer program product for reporting, tracking, and managing rectification of issues within an environment. Embodiments include a method including: receiving at least one image in which a new issue is identified; receiving information relating to the new issue identified in the at least one image; determining a location of the new issue; identifying any existing issues corresponding to the new issue; generating a severity rating corresponding to the new issue; logging the new issue in a database stored in a memory, where logging the new issue in the database includes adding the new issue to an existing issue in response to the new issue corresponding to the existing issue, and logging the new issue in the database includes generating a new issue entry in the database in response to the new issue failing to correspond to an existing issue; and providing the new issue to a service provider for the service provider to resolve.

According to some embodiments, providing the issue to a service provider for the service provider to resolve includes: providing an indication of the new issue identified; providing the severity rating corresponding to the new issue; and providing a virtual marker representing the location of the new issue on a map. The at least one image in which the new issue is identified is received from a provider, where the method of some embodiments further include determining a reliability of the provider based on a determined accuracy of issues previously identified by the provider. Generating a severity rating corresponding to the issue in some embodiments includes identifying risks associated with the issue, wherein risks include one or more of: structural failure, electrical shock, trip hazard, or gas leak.

According to some embodiments, determining the location of the new issue includes: determining a location of an image capture device used to capture the at least one image in which the new issue is identified; and determining an orientation of the image capture device used to capture the at least one image in which the new issue is identified. The information relating to the new issue identified in the at least one image includes a time and date of when the at least one image was captured. The new issue corresponds to the existing issue based, at least in part on the existing issue being located within a predefined distance of the location of the new issue and an issue type of the new issue corresponds with an issue type of the existing issue.

Adding the new issue to the existing issue, in some embodiments, includes: aggregating images corresponding to the existing issue; and providing for display of an augmented reality of the existing issue based on the at least one image in which the new issue is identified and at least one image of the existing issue. An issue type is determined in some embodiments from the at least one image in which the new issue is identified based on processing the at least one image through a machine learning algorithm. Embodiments provided herein include an apparatus including at least one processor and at least one non-transitory memory including computer program code instructions, the computer program code instructions may be configured to, when executed, cause the apparatus to at least: receive at least one image in which a new issue is identified; receive information relating to the new issue identified in the at least one image; determine a location of the new issue; identify any existing issues corresponding to the new issue; generate a severity rating corresponding to the new issue; log the new issue in a database stored in a memory, where logging the new issue in the database includes adding the new issue to an existing issue in response to the new issue corresponding to the existing issue, and logging the new issue in the database includes generating a new issue entry in the database in response to the new issue failing to correspond to an existing issue; and provide the new issue to a service provider for the service provider to resolve.

According to some embodiments, causing the apparatus to provide the new issue to a service provider for the service provider to resolve includes causing the apparatus to: provide an indication of the new issue identified; provide the severity rating corresponding to the new issue; and provide a virtual marker representing the location of the new issue on a map. The at least one image in which the new issue is identified is received from a provider, where the apparatus of an example embodiment is further caused to determine a reliability of the provider based on a determined accuracy of issues previously identified by the provider. Causing the apparatus to generate a severity rating corresponding to the new issue includes, in some embodiments, causing the apparatus to identify risks associated with the issue including one or more of structural failure, electrical shock, trip hazard, or gas leak.

According to some embodiments, causing the apparatus to determine the location of the new issue includes causing the apparatus to: determine a location of an image capture device used to capture the at least one image in which the new issue is identified; and determine an orientation of the image capture device used to capture the at least one image in which the new issue is identified. The information relating to the new issue identified in the at least one image includes a time and date of when the at least one image was captured. The new issue corresponds to the existing issue based, at least in part, on the existing issue being located within a predefined distance of the location of the new issue and an issue type of the new issue corresponds with an issue type of the existing issue.

Causing the apparatus to add the new issue to the existing issue includes, in some embodiments, causing the apparatus to: aggregate images corresponding to the existing issue; and provide for display of an augmented reality of the existing issue based on the at least one image in which the new issue is identified and at least one image of the existing issue. An issue type is determine, in some embodiments, from the at least one image in which the new issue is identified based on processing the at least one image through a machine learning algorithm.

Embodiments provided herein include a computer program product having at least one non-transitory computer-readable storage medium having computer-executable program code portions stored therein, the computer-executable program code portions including program code instructions to: receive at least one image in which a new issue is identified; receive information relating to the new issue identified in the at least one image; determine a location of the new issue; identify any existing issues corresponding to the new issue; generate a severity rating corresponding to the new issue; log the new issue in a database stored in a memory, where logging the new issue in the database includes adding the new issue to an existing issue in response to the new issue corresponding to the existing issue, and logging the new issue in the database includes generating a new issue entry in the database in response to the new issue failing to correspond to an existing issue; and provide the new issue to a service provider for the service provider to resolve.

The program code instructions to provide the new issue to a service provider for the service provider to resolve includes program code instructions to: provide an indication of the new issue identified; provide the severity rating corresponding to the new issue; and provide a virtual marker representing the location of the new issue on a map.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus according to an example embodiment of the present disclosure;

FIG. 2 is a block diagram of a system for managing and resolving issues according to an example embodiment of the present disclosure;

FIG. 3 illustrates an image of an object including an issue according to an example embodiment of the present disclosure;

FIG. 4 illustrates an augmented reality view of the object of FIG. 3 on a device including the issue according to an example embodiment of the present disclosure;

FIG. 5 is a flowchart of a method for managing and resolving an issue according to an example embodiment of the present disclosure; and

FIG. 6 is a flowchart of another method for managing and resolving an issue according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment of the present invention for a method, apparatus, and computer program product for managing problems in an environment, and more particularly, to providing a method, apparatus, and computer program product for reporting, tracking, and managing rectification of issues within an environment. Objects, systems, and all manner of things in the environments in which people live, work, play, and otherwise spend time, are subject to deterioration over time. Whether the deterioration is from environmental conditions causing deterioration over time (e.g., a metal object rusting) or due to incidental damage (e.g., an object being struck by another wayward object), the objects, systems, and other inanimate things are subject to degradation and possible failure depending on their function and purpose.

Given that objects and systems exist everywhere in our environment, it is difficult, if not impossible, to have all of these objects and systems continuously monitored for degradation that may lead to some form of failure. An example embodiment of a limited scope environment may include a facility such as a factory. A factory may be owned and managed by a commercial entity responsible for the upkeep and maintenance of the factory. While a maintenance staff may be employed to maintain the factory including sub-systems, utilities, safety equipment, etc., employing a maintenance staff to continuously observe, monitor, and repair all aspects of the factory may be cost prohibitive, particularly if objects and systems deteriorate prematurely (i.e., before their anticipated life expectancy). Embodiments described herein facilitate the management of issues or problems affecting objects and systems in an environment through crowd-sourcing of information relating to the objects and systems in the environment. These crowd-sourced alerts are used to identify issues, track and manage the issues, and to establish resolution to the identified issues.

According to an example embodiment, an issue may include a leak in a roof of a building, such as a factory. People inside the factory may see the leak in the roof, manifested as a puddle on the factory floor, for example. A device user, such as a user of a mobile phone, may capture an image of the leak in the roof and/or the puddle on the floor. This captured image is then provided to a system that processes the issue. Processing of the issue may include determining information associated with the issue captured in the image. The information of some embodiments includes a type of issue, a scale of the issue, and scope of the issue. The image of the issue may include metadata such as a location at which the image was captured (e.g., a location of the device that captured the image), a viewpoint direction of the device having captured the image (e.g., a direction within a coordinate plane, such as cardinal directions and an angle of elevation), and a timestamp indicating a time and date of when the image was captured.

While example embodiments described herein generally refer to the capturing of an image of an issue, embodiments may include capturing a plurality of images, such as in a video, time lapse, or images from different perspectives (e.g., different image capture device orientations) to facilitate identification, management, and resolution of the issue. Further, beyond image and video capture, embodiments may employ different types of sensors for capturing information pertaining to the issue. For example, forward-looking infrared (FLIR) camera images that identify temperatures of features within an image may be captured to visually describe an issue. Similarly, light distancing and ranging (LiDAR) may be used to generate a three-dimensional point cloud of the issue. Images of an issue may therefore be in the form of LiDAR point clouds, FLIR images, video, or the like that present a visual depiction of an issue in one form or another. Embodiments may use audio sensors for capturing information relating to an issue, which may be useful for issues that present themselves in the form of noise (e.g., grinding gears, squeaky belts, air leaks, etc.). Thus, while embodiments described herein include capturing of images of issues, embodiments may include capturing any form of multi-media associated with an issue that may inform an issue owner or issue manager of the issue.

The system of example embodiments uses the image of the issue and the information associated with the issue to determine a severity rating corresponding to the issue. The severity rating may be indicative of a safety risk, a potential for collateral damage, or a degree of deterioration, for example. A safety risk in the above-described roof leak scenario may include a slip hazard for people walking through the puddle caused by the roof leak. Collateral damage from the roof leak may include damage to contents of the factory, such as damage to materials, damage to machines, or damage to the structure of the factory building. A degree of deterioration for the roof leak example may include a size of the leak, such as a roof leak of an occasional drip versus a steady stream of water. The severity rating may be a combination of all risks associated with the identified issue, with safety, collateral damage, and degree of deterioration each being a component of the severity rating. The safety component of a severity rating may be a substantial component, particularly when the safety risk involved includes a high likelihood of injury or worse. A collateral damage component may be weighed based on a cost of potential collateral damage. A deterioration component may be proportional to the degree of deterioration of the object or system identified in the issue. When an issue has a high likelihood of injury, a high degree of collateral damage, and a significant degree of deterioration, the issue may be elevated to require an emergency resolution.

The image of the issue, information associated with the issue, and the severity rating of the issue may be stored in a database. Referring again to the factory roof leak example, the owner of the factory may maintain a database of issues associated with the factory that can be used for logging issues and rectifying the issues. This database may be stored in a memory accessible to maintenance staff. The issues within the database may be prioritized based on different aspects of the issues. For example, issues with a high severity rating may be prioritized while those with a low severity rating may be made of lower priority.

The database of issues may be provided to a maintenance staff such that they can address the issues. According to some embodiments, certain issues may be routed to a particular entity that is specifically suited to address the issue. In the case of a roof leak, the issue may be routed to a service provider for resolution. Optionally, an issue may be routed to a plurality of service providers for obtaining estimates for repair of the issue, whereby the entity responsible for the building (or object, system, etc.) can be provided with the estimates before selecting a service provider to resolve the issue.

As described herein, example embodiments of the claims may provide a method, apparatus, and system for reporting, tracking, and managing resolution of issues within an environment. Embodiments of an apparatus as described herein may include devices such as mobile phones, tablet computers, fixed computers (e.g., desktop computers), or the like. These apparatuses can perform the methods described herein and can be a component of the system of example embodiments for reporting, tracking, and managing resolution of issues within the environment. One example embodiment that will be described herein includes a user device such as a mobile phone or smart phone. Such a device may be a mobile personal device that a user may carry with them as they move within an environment.

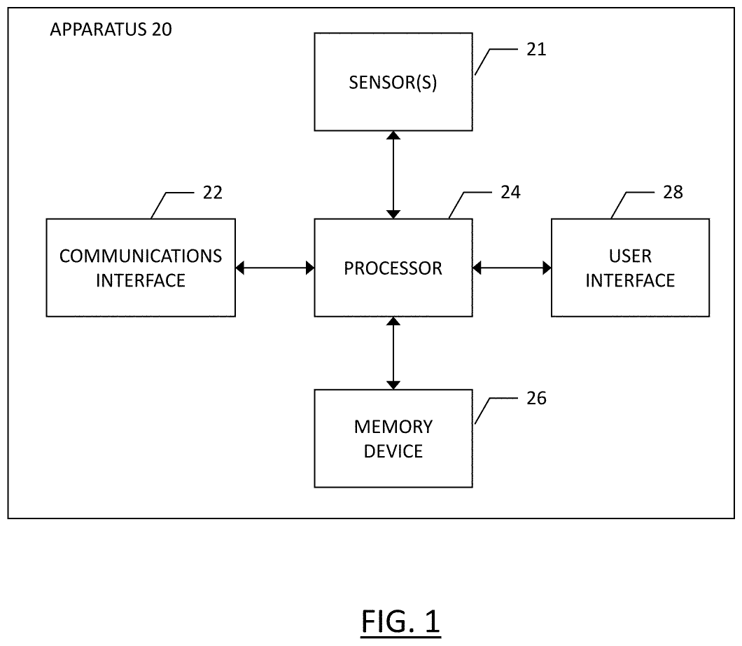

FIG. 1 is a schematic diagram of an example apparatus configured for performing any of the operations described herein. Apparatus 20 is an example embodiment that may be embodied by or associated with any of a variety of computing devices that include or are otherwise associated with a device configured for capturing images of issues or processing and managing issues reported. For example, the computing device may be a mobile terminal, such as a personal digital assistant (PDA), mobile telephone, smart phone, smart watch, tablet computer, camera or any combination of the aforementioned and other types of voice and text communications systems. Optionally, the computing device may be a fixed computing device, or the like.

Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 20 may be equipped with any number of sensors 21, such as a global positioning system (GPS), image capture sensor, inertial measurement unit (IMU), accelerometer, and/or gyroscope. Any of the sensors may be used to sense information regarding the movement, positioning, or orientation of the device and for determining a position and orientation of the device when images of issues are captured as described herein according to example embodiments. Further, the sensor(s) 21 may include an image capture sensor to capture images of issues as described herein.

The apparatus 20 may include, be associated with, or may otherwise be in communication with a communication interface 22, processor 24, a memory device 26 and a user interface 28. In some embodiments, the processor (and/or co-processors or any other processing circuitry assisting or otherwise associated with the processor) may be in communication with the memory device 26 via a bus for passing information among components of the apparatus. The memory device 26 may be non-transitory and may include, for example, one or more volatile and/or non-volatile memories. In other words, for example, the memory device 26 may be an electronic storage device (for example, a computer readable storage medium) comprising gates configured to store data (for example, bits) that may be retrievable by a machine (for example, a computing device like the processor). The memory device 26 may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 24 may be embodied in a number of different ways. For example, the processor 24 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 24 may be configured to execute instructions stored in the memory device 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor 24 is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, physical buttons, and/or other input/output mechanisms. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 26, and/or the like).

The apparatus 20 of an example embodiment may also optionally include a communication interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE). In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s).

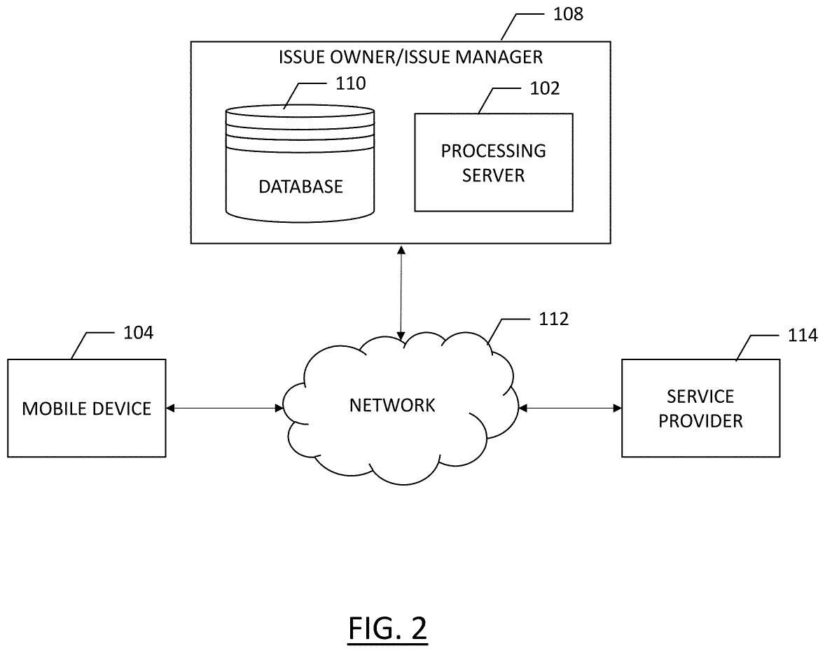

According to example embodiments, an issue owner and/or issue manager may facilitate the gathering of identified issues, managing the issues, and facilitating resolution of the issues. FIG. 2 illustrates a communication diagram of an example embodiment of a system for implementing example embodiments described herein using an issue owner/issue manager 108 and a mobile device 104. The illustrated embodiment of FIG. 2 includes a mobile device 104, which may be, for example, the apparatus 20 of FIG. 1, such as a mobile phone, tablet computer, or the like, and an issue owner/issue manager 108. Each of the mobile device 104 and an issue owner/issue manager 108 may be in communication with at least one of the other elements illustrated in FIG. 2 via a network 112, which may be any form of wireless or partially wireless network as will be described further below. Additional, different, or fewer components may be provided. For example, many mobile devices 104 may connect with the network 112. The issue owner/issue manager 108 may be cloud-based services and/or may operate via a hosting server that receives, processes, and provides data to other elements of the system.

The issue owner/issue manager 108 may include a party responsible for addressing issues within a particular environment. The issue owner/issue manager 108 may be, for example, a building owner (e.g., office building, residential building, retail building, warehouse, factory, etc.), a tenant of a building (e.g., a company leasing a space), a municipality (e.g., a city, a county, or other governmental entity), etc. The issue owner/issue manager 108 may be responsible for a defined area within which issues belong, at least in part, to the issue owner/issue manager. Optionally, a responsible party or issue owner such as a building owner may employ a third party service as the issue manager. An issue manager may handle the issues identified for an issue owner. In some instances, issue management may be more efficiently or effectively handled by a provider that is experienced in issue management.

The issue owner/issue manager 108 includes a database 110 that may include the identified issue log as described above. A processing server 102 may receive issues from a plurality of sources (e.g., mobile device 104) as described further below, such as over the network 112. The processing server may be embodied as the apparatus 20 described above with respect to FIG. 1. One or more service providers 114 may be in communication with the issue owner/issue manager 108 over the network 112 to facilitate resolution of any identified issues. The service provider 114 may include services such as security, electrical, plumbing, roofing, cleaning, etc., as described further below.

Example embodiments provided herein provide a method of reporting, tracking, and managing resolution of issues within an environment. Methods described herein receive an image relating to a new issue, receive information relating to the new issue in the image, determine a location of the new issue, identify any existing issues corresponding to the new issue, log the new issue in a database, and provide the new issue to a service provider for the service provider to resolve.

Objects and systems that are susceptible to wear, deterioration, and damage are often considered on a maintenance schedule that corresponds to the anticipated life of various materials and components. Infrastructure elements are one example of objects that have a design life and are periodically inspected for deterioration. A bridge, for example, may have a design life of seventy years; however, it may be inspected every five-to-ten years for structural issues. Such periodic inspection may not be sufficient to detect anomalies in degradation that may be caused by unexpected events or may be due to materials that fail to meet expectations. As such, degradation may occur prematurely and may not be detected through a routine periodic inspection when the intervals between inspections are relatively long. Embodiments described herein provide a mechanism by which issues, such as deterioration, damage, wear, safety hazards, or the like can be identified and reported such that they can be addressed and resolved as needed.

While embodiments described herein may be well suited to address and manage issues with infrastructure elements, embodiments may be implemented in a wide variety of applications. Embodiments may be implemented for any type of environment in which objects or systems are subject to deterioration, wear, or failure, and where safety concerns may exist. Buildings such as factories, office buildings, warehouses, residential buildings, or the like may similarly benefit from embodiments described herein.

According to an example embodiment, an apparatus, such as a mobile device 104 carried by a person may be used to identify an issue. A person may capture an image of an issue that they observe. The issue may be any form of abnormality, such as deterioration, wear, damage, safety hazard, etc. The captured image may be provided to an issue owner/issue manager 108. The issue owner/issue manager may be an entity responsible for maintenance or repair in a particular area. If the issue is identified within a building, the issue owner/issue manager may be an owner or manager of the building. If the issue is identified along a public road, the issue owner/issue manager may be a governmental entity, such as a transportation department. The issue owner/issue manager 108 may be identified by a location of the issue captured in the image. The person capturing the image may interface with an application (e.g., an app on a mobile device) or a website interface through which the image is provided to the issue owner/issue manager.

According to some embodiments, a single interface may be provided through an application or website through which any issue at any location is provided by a person, and the single interface identifies the issue owner/issue manager through the location of the issue captured in the image. Such an embodiment would not require a person to interface with a building-specific or owner-specific portal. Some issue owners/issue managers may prefer to have their own portal through which issues can be reported which may allow them to customize their user interface according to their specific needs.

The image of the issue captured by a person is received by the issue owner/issue manager 108. Additional information may be provided by the person who captured the image, such as a location, time/date, and a description of the issue. However, embodiments may determine information relating to the issue through other processes that places less burden on the person capturing the image. Optionally, information discerned by embodiments described herein may be used to supplement any information provided by the person providing the image of the issue.

Whether discerned by the issue owner/issue manager as described further below or provided by a person, information relating to the issue is established to facilitate management and resolution of the issue. The information associated with or relating to the issue captured in the image may include a location, such as a latitude and longitude. Optionally, the location may include an elevation. The location may optionally include an identification of a location within a building, such as within a particular room of a building or proximate a location identifier within a building. The location information may be provided by the person capturing the image, or the location information may be in the form of metadata attached to the image, whereby the device capturing the image records the location of the device at the time of image capture. The location information provided by a device may be discerned from a location sensor (e.g., sensor(s) 21 of apparatus 20) which may include a GPS sensor or other location determination sensor.

In addition to a location of the image, an orientation of the device having captured the image may be determined. The orientation may be in the form of cardinal directions and an elevation angle, or may be an orientation with respect to the issue captured in the image, for example. While the location information may establish an approximate location of the issue in the image, depending on the location sensor type used, the accuracy of the location may be approximate (e.g., within several meters). Further, the image of the issue may be captured at a distance from the issue. The distance from the issue captured in the image may be approximated by a user capturing the image, or the device may be equipped with a sensor capable of establishing distance to a focal point of the image. The orientation information may be used in conjunction with the location information to better narrow the location of the issue and to help pinpoint the issue location for more accurate management and resolution.

While location and orientation information may be discerned, embodiments may optionally use other locating means to establish where the image of the issue was captured. Object recognition within an image may provide a mechanism by which the location of the image captured may be determined with a high degree of accuracy. Object recognition can interpret both a location and a perspective of an object to determine location and orientation of the device capturing the image. Object recognition may be used in conjunction with a location, even if the location is approximate, to narrow candidate locations determined from object recognition.

Identifying the location of an issue in a captured image establishes where the issue is. Determining what the issue is or what type of issue is captured in the image further facilitates management and resolution of the issue. A person who captured the image of the issue may identify a type of issue or identify what the issue is that they captured. However, the person may not know exactly what the issue is, or may incorrectly identify the issue. Further, placing the burden of identifying a type of issue on a person may dissuade a person from reporting an issue. Embodiments described herein may employ machine learning algorithms and artificial intelligence to determine issue types and to identify the issues.

Machine learning may learn different types of issues from training data that includes images with issues positively identified to train the machine learning algorithm to recognize issues and issue types. A simplistic example of such issue identification from machine learning may include where a reflection is identified within the image, which may relate to a fluid leak since the surface of a fluid may be reflective. Various other aspects of issues may be used to discern from an image what the issue is and what type of issue is captured in the image. Issue types may range from safety issues to structural issues to deterioration/erosion issues, for example. The issue itself may include a narrower description than the issue type. An issue type may include a safety hazard, while the issue identified may be a leak causing a puddle in a walkway that becomes a slip-and-fall hazard. Machine learning and artificial intelligence can be used to determine issues and issue types to properly identify the issue and to establish a severity of the issue.

Once an issue type and issue are identified, a severity rating may be established to communicate an urgency with which an issue should be resolved. Safety issues may be a high priority, and different levels of safety issues may provide different levels of severity. Beyond safety, the potential for collateral damage and a degree of deterioration or damage may be used to establish a severity rating. The severity rating may include a score, where the score reflects a combination of elements and the urgency for resolution of the issue. Issues that may result in injury may have a very high severity rating score, even if other components of the severity rating are low. For example, a missing or deteriorated safety railing may not pose a risk to a structure or have any potential collateral damage to an environment; however, a missing or deteriorated safety railing can lead to an injury from falling. Thus a missing or deteriorated safety railing may have a very high severity rating score. Conversely, a deteriorated informational sign may pose little if any safety risk, but may be more of an inconvenience for those who would otherwise benefit from information on the sign. Such an issue would merit a relatively low severity score.

The issue identified in an image captured by a person can be logged into a database, such as database 110, where the issue can be managed through prioritization and routing to a service provider 114 as appropriate. While the person who captured the image can provide information pertaining to the issue, according to some embodiments, the information relating to the issue is identified through machine learning and through discerning information from the image and metadata thereof. To better inform an issue owner/issue manager 108 of the issue and the severity, an issue summary may be generated for the database. The issue summary may be generated through natural language generation. Natural language generation may be used to generate a summary of the issue including a severity, and may optionally be used to generate an instruction for resolution of the issue or a request to a service provider for resolution. Natural language generation can be implemented to request a quote from a service provider to determine what the timing and cost may be to resolve the issue identified in the image.

Logging of the issues in the database 110 provides a resource for the issue owner/issue manager 108 to use in improving the objects and systems under their responsibility. Issues in the database can be prioritized for resolution, where the prioritization can be based on severity rating score of the issue together with other variables to identify which issues require resolution most quickly. The prioritization of issues may include factors other than the severity rating score, such as financial factors, previously scheduled resolution, seasonal factors (e.g., resolution may not be possible during very cold weather), outward appearance (e.g., an issue may not be severe, but may reflect poorly on the owner), etc. While severity rating score may be a significant factor in prioritizing issue resolution, financial metrics may further impact prioritization. An issue owner/issue manager 108 may not have sufficient budget to resolve all issues identified in a list of issues from their database. The issues that involve safety, potential loss of revenue (e.g., through loss of use of a system or area), or having a high cost of delay may be prioritized while other issues may be of lower priority. The prioritization of issues may be based on owner preferences, whereby issues that are determined by the owner to be of high importance are prioritized, while issues of lesser importance are given lower priority. Issues that are purely or substantially cosmetic are examples of issues that may be prioritized differently between different owners. An issue owner/issue manager 108 responsible for a luxury resort may deem cosmetic issues to be of substantial importance, while a factory owner concerned primarily with functionality may not afford cosmetic issues such importance. Similarly, cleanliness issues may differ between issue owner/issue managers, where a restaurant owner prioritizes cleanliness issues, while a warehouse owner may not prioritize cleanliness issues.

Issues that are logged into the database 110 may be provided to a service provider 114 for evaluation of the issue. The issue owner/issue manager 108 may manually send out issues to service providers for quotes on resolution, or embodiments may automatically provide issues to service providers for quotation. The issues may be provided to service providers relevant to the specific issue identified. In an example embodiment where an air conditioning issue is identified, the issue may be logged in the database and sent to one or more heating, ventilation, and air conditioning (HVAC) contractors for quotation. The service providers used for various types of issues may be specified by the issue owner/issue manager 108 in a list of preferred vendors.

The methods of example embodiments may further manage the resolution of the issue through facilitating the acceptance of a quotation from a vendor to perform a repair or otherwise resolve an issue. Once the service provider 114 is contracted, they may resolve the identified issue. The issue owner/issue manager 108 may be alerted to the resolution. The service provider may, in some cases, capture images of the repaired issue and send those images to the issue owner/issue manager 108 together with an identification of the issue in the database 110, such that the issue owner/issue manager can review the issue resolution against the issue information in the database. If the issue owner/issue manager would prefer to review the issue in person, they may do so by visiting the location identified as the location of the issue from the original captured image of the issue. If the resolution is to the satisfaction of the issue owner/issue manager 108, the issue owner/issue manager may mark the issue in the database as resolved, and release funds to pay the service provider.

Issues may, in some instances, be complex and/or difficult to find and assess. Embodiments described herein provide a mechanism by which issues are clarified to a user, such as an issue owner/issue manager 108 or a service provider 114, for example. The image of an issue captured by a user may be used to identify the issue type, issue location, issue severity, etc. Further, the location of the issue may be marked on a map. A user may wish to see the issue themselves, such that they can select the issue, such as from a list in database 110, and see a location of the issue. The location may be identified, such as by a marker on a map view of the region of the location. The map view may be a conventional map of an area including roads, bodies of water, buildings, etc. Optionally, a map may be a map of a floorplan of a building. The location of an issue may be presented on the map, regardless of type, to provide the user a visual indication of where they need to be to view the issue.

Once a user reaches a location at which they are to view an issue, the issue may not be readily apparent. To assist a user, a more specific position of the issue in the surroundings of the user at the location may be provided. This specific position may be facilitated by the orientation of the image captured by the person who captured the image of the issue originally. To direct a user's attention to the issue, augmented reality may be employed. A user may use an image capture device, such as a smart phone, tablet computer, etc. and hold the device, which may be embodied by mobile device 104 as apparatus 20, in front of them such that they can view a display of the device. The display may present an image of what is in the field-of-view of a camera of the device. If the issue is not in the field-of-view of the camera, an arrow may be provided for display to guide the user to move the device in a direction that will lead to the issue coming into the field-of-view of the camera. Once the issue is within the field-of-view of the camera of the device, the issue is provided for display on the device.

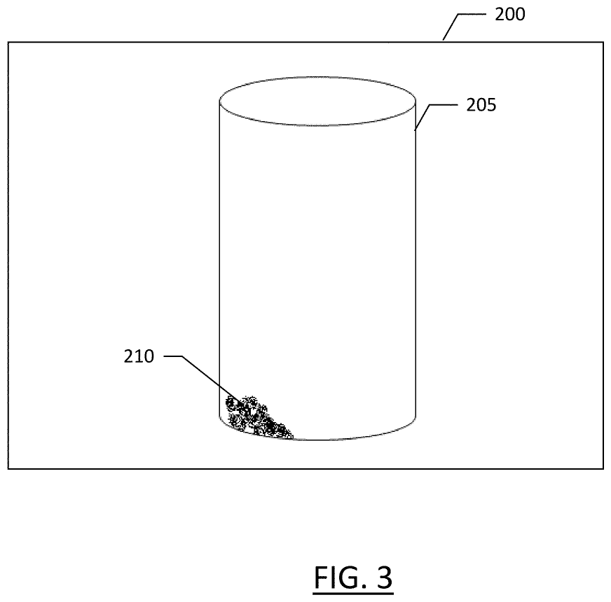

FIG. 3 illustrates an example embodiment of an issue. According to the illustrated embodiment, a chemical tank 205 is shown with corrosion 210 forming near the bottom of the chemical tank 205 as captured in an image 200 by a person. The corrosion may be identified by the person as the issue and the issue may be logged into the database 110 as described above. The location and orientation of the device capturing the image of the issue may inform an issue owner/issue manager 108 of the location of the chemical tank 205 which may enable them to identify the chemical stored in the tank. The type of chemical stored in the tank may be used to determine, at least in part, a severity of the issue. The corrosion 210 that is the issue may be of unknown severity. The severity of the corrosion 210 may be estimated through machine learning or by an experienced operator viewing the image 200; however, physical observation of the corrosion 210 on the tank 205 may be necessary to establish the severity of the issue.

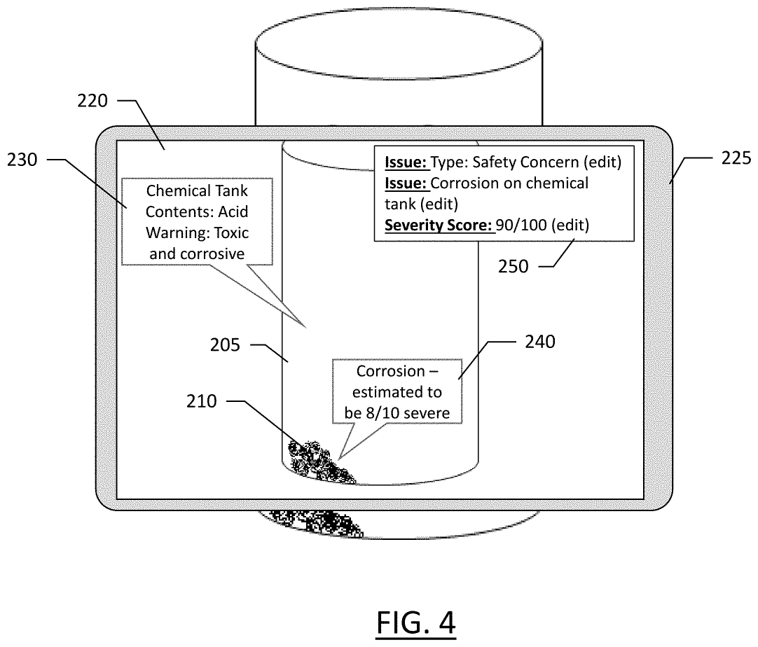

As noted above, a user may be guided to the location of the issue through a map and then through use of a mobile device 104 having a display (e.g., user interface 28 of FIG. 1). The mobile device 104 having the display may also be used for an augmented reality display of the issue once the issue is located in the field-of-view of the device. FIG. 4 illustrates an example embodiment of an augmented reality display of the issue of FIG. 3. An image 220 including the issue may be provided for display on a device 225 showing the chemical tank 205. The device 225 is held in front of the tank 205 such that the chemical tank 205 and the corrosion 210 are in the field-of-view of the camera of the device and provided for display on the display of the device.

The augmented reality view of the chemical tank 205 on the display of the device 225 shows the chemical tank 205 with an overlaid identifier 230 indicating the chemical tank contents and a warning about the toxic and corrosive contents. Also shown in the augmented reality view is an identifier of the issue 240 describing the issue of “corrosion” with an estimated severity of the corrosion to be eight of ten. The estimated corrosion may be entered by a user, such as the person who captured the original image of the issue, or established by machine learning through an analysis of the corrosion in the image. A summary 250 of the issue is shown including the issue type, the issue description, and the severity score. The issue shown is a safety concern due to the toxicity of the chemical contents of the chemical tank 205, while the issue itself is corrosion of the chemical tank. The severity score is shown as a ninety on a one hundred point scale, where the severity may be high due to the safety concerns. Each of the issue type, issue, and severity score of the summary 250 of the issue are shown to be editable. These elements may be generated through machine learning and through natural language generation, such that upon observation by an issue owner/issue manager 108 or their responsible designee, these items may change. For example, the corrosion may only be surface rust that doesn't compromise the integrity of the chemical tank 205, such that the corrosion may have an actual, observed severity of one of ten, which may reduce the severity score to a ten of one-hundred due to the lack of imminent safety concerns.

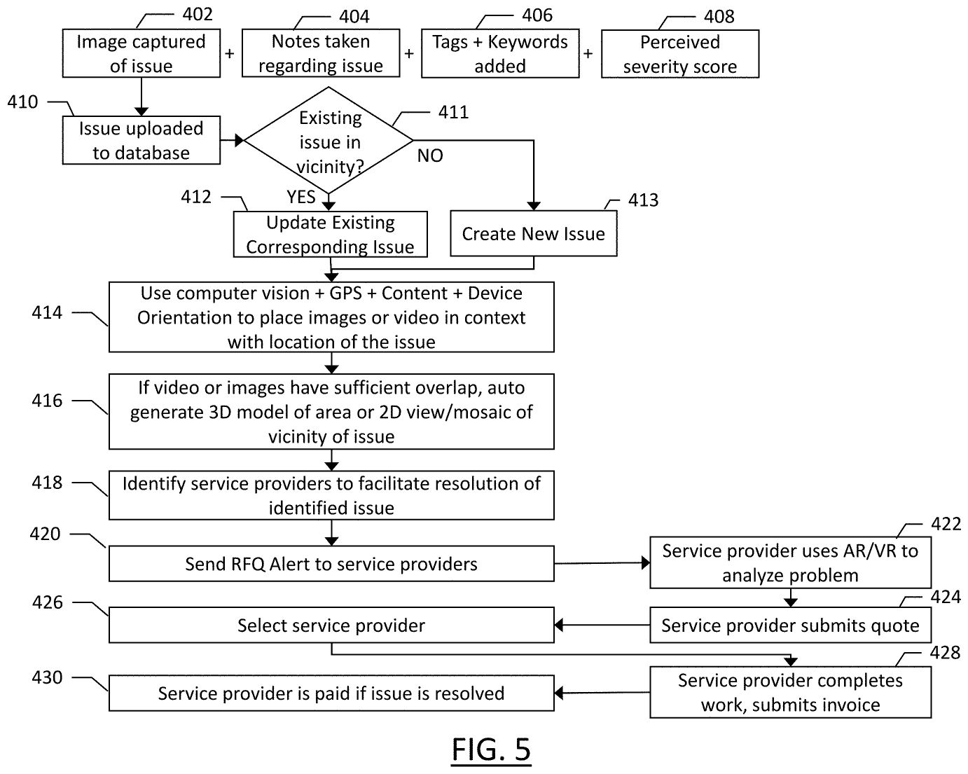

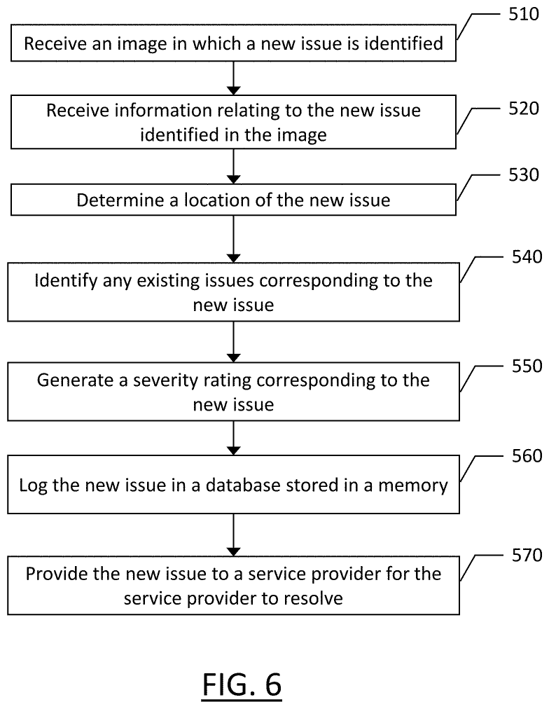

FIGS. 5 and 6 are flowcharts illustrative of a method according to example embodiments of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 of the apparatus 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

As illustrated in FIG. 5, an image of an issue is captured at 402. The image may be a series of images, such as a video or time lapse image capture. While an image or images alone may be provided as an indication of the issue, embodiments may provide a user interface by which a person may enter details relating to the issue to help issue resolution. Notes may be entered regarding the issue at 404, keywords and tags may be added at 406, and a perceived severity score may be added at 408. The notes taken may include a description of the issue, specific location of the issue, perceived safety or security hazards, etc. Keywords and tags may be identifiers that help categorize the issue, such as “leak” or “trip hazard” or other words that may convey information on the issue or issue type. The perceived severity score may be a user estimated score relating to the severity of the issue. This score provides an indication to an issue owner/issue manager of how dire the issue is perceived to be by a particular user.

The image or images of the issue together with any additional information is provided to the database at 410. The database may be that of a issue owner/issue manager 108 as shown in FIG. 2, or the database may be a larger scale database that includes issues for many issue owners whereby a database service provider distributes issues to their respective owners based on information relating to the issue, such as the location of the issue. At 411 the location of the issue is used to determine if any existing issues are in the vicinity of the identified issue. If there is an existing issue or “YES”, a comparison may be made to confirm that the existing issue corresponds with the identified issue such that the issue information can be combined. If the existing issue corresponds with the issue captured in the image, the existing, corresponding issue is updated at 412 with the new information and new image. If there is no existing issue or “NO”, a new issue is created at 413. At 414 computer vision/object detection, GPS or other locating means, content of the issue uploaded at 410, and orientation of the device capturing images of the issue are used in context with the location of the issue. At 416, if video images have been provided with sufficient overlap, a three-dimensional model of the issue can be generated. Optionally, using fewer images or fewer perspectives of the issue, a two-dimensional view/mosaic of the issue and area around the issue may be generated.

Based on the information associated with the issue, service providers are identified at 418 to facilitate resolution of the identified issue. The service providers may be identified based on a list of issue owner identified service providers and the capabilities of the service providers relative to the identified issue. A request for quote (RFQ) is sent to the selected service providers at 420. The selected service providers analyze the request to establish if they can resolve the issue, and if so, at what cost. The service provider may use the images of the issue to determine a scope of the issue and to more accurately quote the resolution. Using the images of the issue, an augmented reality or virtual reality interaction with the issue may be provided to the service provider for them to analyze the issue.

A quote from the service provider is generated and sent at 424 to an issue owner or issue manager. The issue owner/issue manager then selects a service provider at 426 and notifies the service provider. The service provider completes the work and submits an invoice at 428. The invoice may be accompanied by new images of the resolved issue to confirm to the issue owner that the issue has been resolved. If the issue has been resolved to the satisfaction of the issue owner, the service provider is paid at 430 and the issue is closed in the system and database.

According to example embodiments provided herein, issue reporting can be a crowd-sourced endeavor by receiving issues from a variety of individuals. A user interface may be provided through a mobile device application or through a website through which a person may report an issue through the capturing and uploading of an image of the issue, with or without further characterization such as notes taken (element 404 of FIG. 5), tags and keywords added (element 406 of FIG. 5), or a perceived severity score (element 408 of FIG. 5). Beyond an application or user interface, embodiments may scour or scrape other data sources to identify issues. For example, a social media feed may include images captured of issues and may include conversation or details about the issue. According to an example embodiment, a social media page for a building may receive comments and images of issues of cleanliness or disrepair. Those images and issues can be captured and uploaded to a database of the issue owner/issue manager for the building.

The crowd sourcing of issues promotes rapid identification of issues and provides more information about issues that are identified through the variety of sources through which the issue is identified. Crowd sourcing is beneficial as it uses information from a multitude of sources and can gather the information for little to no cost. Some embodiments may incentivize issue reporting where the issue reporting is beneficial to the issue owner/issue manager. Incentives may include promotions (e.g., coupons, gift cards, etc.) or other compensation provided to a user when an issue they actively reported (rather than being harvested through social media streams) is used to facilitate a resolution to the issue.

Optionally, in some embodiments, a person who reports an issue may be provided status updates with respect to the issue. Certain embodiments described herein may include the reporting of issues by users where the issue is highly relevant to the reporting person. For example, in a residential apartment building a resident may report a stairwell light that is broken. The user may avoid that stairwell knowing that it is dark, such that they have an interest in when the light is repaired. According to such an embodiment, a user who reports an issue may receive a benefit of being alerted to the issue being resolved. This provides an incentive for a user to report an issue.

Crowd sourcing of information pertaining to issues may result in some erroneous reporting of issues where a user may improperly report an issue or report an issue that does not actually exist. Embodiments described herein may assign a reliability to a user based on historical issue reporting from that user. A user who has reported only valid issues that require resolution and done so accurately (e.g., with accurate notes and keywords) may be afforded a high reliability rating such that future issue reports from that user are trusted. Further, if a user is deemed to have accurately estimated a severity score for an issue may be trusted to report an accurate severity score. Conversely, users who report invalid or incorrect issues may receive a low reliability score, and issues reported by such users in the future may be given a lower priority or discarded entirely. Further, reliability scores may be assigned or based in part on a role of a user reporting the issue. For example, a maintenance staff member may be prescribed a very high reliability rating as their role suggests that they would be skilled at identifying issues and establishing their scope. An unknown individual may not be assigned a high reliability as their reliability is as of yet unknown.

Reliability ratings may further be influenced by a type of issue reported. For example, a security staff member for a building may have a high reliability rating when reporting issues relating to security (e.g., broken lights, faulty door locks, etc.); however, their reliability rating may be low in reporting issues associated with maintenance, such as faulty HVAC or utility systems. Thus, a reliability rating of a person may vary based on their roles and vary based on the type of issue they are reporting. Issues reported from a user with a high reliability rating relative to the type of issue reported may be prioritized and investigated more quickly relative to issues reported from a user having a low reliability rating relative to the type of issue they reported.

As described with respect to element 412 of the flowchart of FIG. 5, when an issue is received by the issue owner/issue manager, the issue could be duplicative of an existing, known issue in the database. To determine if the new issue correlates with an existing issue, embodiments determine if there are any existing issues in the vicinity of the location identified in the new issue. The vicinity may be a predefined distance, which may vary depending upon the type and size of issue reported. For example, a roof leak of a building may be a relatively concise issue with a predefined distance or vicinity about the roof leak of a few meters, while an issue such as a deteriorating bridge may be a larger scale issue and may have a predefined distance or vicinity of tens of meters. Embodiments described herein identify the issue and issue type and establish a relevant vicinity about the issue. If a new issue is reported, a search may be performed to determine if there is an existing issue within the vicinity of the new issue. The vicinity may be established by the existing issues in the database, or by the new issue being reported.

If an existing issue is determined to exist within the vicinity of the new issue, a comparison of the issues may be performed to determine if the new issue is the same as the existing issue. The comparison may include a comparison of the issue type and actual issue identified. As issues may be reported differently by different people, the comparison does not necessarily look for an identical match. For example, a roof leak issue may be reported by a first source, while a puddle on the floor below the same roof leak may be reported as an issue by a second source. These issues are related and stem from the same root cause, such that they can be established as the same issue in some embodiments. Thus, the comparison of existing issues with new issues compares issues within a predefined degree of similarity or issues that may be otherwise related.

If there is no existing issue within the vicinity within the predefined degree of similarity of the new issue, a new issue is created in the database. If there is an existing issue within the vicinity and within the predefined degree of similarity, the new issue is added to the existing issue. The addition of the new issue to the existing issue provides additional images of the issue together with potentially new information. The new imagery can be used together with the existing imagery to facilitate the generation of a three-dimensional model or two-dimensional view/mosaic of the area around the issue as shown in operation 416 of the flowchart of FIG. 5. A plurality of images of the same issue can be used for layering. Images of the same issue at the same location from different perspectives can be used in layering to layer the images on top of one another permitting an augmented reality view of the issue. A user can move along a timeline of the layered issues going through layers of the issue in a temporal basis to establish a change and rate of change in an issue.

When a new issue correlates to an existing issue, the time of capture of the images of the issue can be used to develop a timeline of the issue. The timeline of the issue can be used to establish deterioration or change occurring in the issue from one period in time to another. Further, the timeline can be used to predict a progression of the issue, potentially predicting a failure of an object or system. The progression of an issue over time can influence the severity rating score of the issue as progression can demonstrate if deterioration is occurring rapidly or at a relatively slow pace. Further, the timeline can establish a deadline by which an issue requires resolution before the issue progresses to a safety hazard, a failure, or a much more costly issue to resolve, for example.

The timeline of progression of an issue available through images taken of the issue at different periods of time can optionally be used in augmented or virtual reality to present or animate the progression of the issue over time. Further, such progression can illustrate how an issue changes over time. The imagery from an issue over time can further be used for training a machine learning model that can determine progression of issues over time and predict progression and failure of issues.

While example embodiments described above include people capturing images of issues and reporting the issue to an issue owner or issue manager, embodiments provided herein may optionally include issues reported by unmanned devices, such as unmanned aerial vehicles, surveillance cameras, self-driving car sensors, or the like. Images may be captured of the environment of an unmanned aerial vehicle as they travel along a travel path. These images can be processed by a machine learning algorithm to identify anomalies in the images that represent issues, and the issues can be analyzed for issue type and severity. According to some embodiments, unmanned aerial vehicles may be configured to follow a particular path used to monitor an environment and travel in locations from which images of critical objects and systems may be captured and specifically, areas of objects and systems that are prone to issues such as areas susceptible to corrosion, impact, or other source of damage.

Methods described herein provide a mechanism by which issues can be identified, located, and managed through crowd sourced information. Embodiments provide an apparatus, computer program product, and method for managing issues in an environment and for reporting, tracking, and resolving issues within the environment.

FIG. 6 is a flowchart illustrating a method for reporting, managing, and resolving issues. An issue may be captured in an image by a provider which may include a person or an autonomous vehicle, for example. At 510, an image in which a new issue is identified is received, such as by an issue owner/issue manager 108 as shown in FIG. 2. Information relating to the new issue identified in the issue is received at 520. This information may be provided by the provider in the form of keywords, tags, notes, or the like. Optionally, the information may be established from the image, such as from metadata, or from image analysis, for example. A location of the new issue is determined at 530. The location may be determined by the metadata of the image, provided by the image provider, or established based on the information received with the issue. At 540, any existing issues that correspond to the new issue are identified. Existing issues may be established based on how close the location of an existing issue is to the new issue, and if an issue type of the new issue corresponds to an existing issue within a predefined distance of an existing issue, for example. A severity rating for the issue is generated at 550. This may be generated based on information from the provider, or may be determined based on image analysis, or a combination thereof

As shown in FIG. 6 at 560, the new issue is logged in a database stored in a memory, such as database 110 of FIG. 2. According to some embodiments, if the new issue corresponds with an existing issue, the new issue is appended to the existing issue. If the new issue fails to correspond with an existing issue, a new issue entry in the database may be generated. At 570, the new issue is provided to a service provider for the service provider to resolve. According to some embodiments, the new issue may be provided to a plurality of service providers to obtain a quote of a cost and timing to resolve the new issue. Upon receiving the quotes in return, an issue owner/issue manager may decide on a service provider and select them to perform whatever actions are necessary to resolve the issue.

In an example embodiment, an apparatus for performing the method of FIG. 5 or 6 above may comprise a processor (e.g., the processor 24) configured to perform some or each of the operations (402-430 and/or 510-570) described above. The processor may, for example, be configured to perform the operations (402-430 and/or 510-570) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 402-430 and/or 510-570 may include, for example, the processor 24 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for managing crowd-sourced issues comprising:
receiving at least one image in which a new issue is identified;
receiving information relating to the new issue identified in the at least one image;
determining a location of the new issue;
identifying any existing issues corresponding to the new issue;
generating a severity rating corresponding to the new issue;
logging the new issue in a database stored in a memory, wherein logging the new issue in the database comprises adding the new issue to an existing issue in response to the new issue corresponding to the existing issue, and logging the new issue in the database comprises generating a new issue entry in the database in response to the new issue failing to correspond to an existing issue; and
providing the new issue to a service provider for the service provider to resolve.

2. The method of claim 1, wherein providing the new issue to a service provider for the service provider to resolve comprises:
providing an indication of the new issue identified;
providing the severity rating corresponding to the new issue; and
providing a virtual marker representing the location of the new issue on a map.

3. The method of claim 1, wherein the at least one image in which the new issue is identified is received from a provider, the method further comprising:
determining a reliability of the provider based on a determined accuracy of issues previously identified by the provider.

4. The method of claim 1, wherein generating a severity rating corresponding to the new issue comprises identifying risks associated with the new issue, wherein risks include one or more of: structural failure, electrical shock, trip hazard, or gas leak.

5. The method of claim 1, wherein determining the location of the new issue comprises:
determining a location of an image capture device used to capture the at least one image in which the new issue is identified; and
determining an orientation of the image capture device used to capture the at least one image in which the new issue is identified.

6. The method of claim 1, wherein the information relating to the new issue identified in the at least one image comprises a time and date of when the at least one image was captured.

7. The method of claim 1, wherein the new issue corresponds to the existing issue based, at least in part on the existing issue being located within a predefined distance of the location of the new issue and an issue type of the new issue corresponds with an issue type of the existing issue.

8. The method of claim 7, wherein adding the new issue to the existing issue comprises:
aggregating images corresponding to the existing issue; and
providing for display of an augmented reality of the existing issue based on the at least one image in which the new issue is identified and at least one image of the existing issue.

9. The method of claim 1, wherein an issue type is determined from the at least one image in which the new issue is identified based on processing the at least one image through a machine learning algorithm.

10. An apparatus comprising processing circuitry and at least one memory including computer program code, the at least one memory and the computer program code configured to, with the processing circuitry, cause the apparatus to at least:
receive at least one image in which a new issue is identified;
receive information relating to the new issue identified in the at least one image;
determine a location of the new issue;
identify any existing issues corresponding to the new issue;
generate a severity rating corresponding to the new issue;
log the new issue in a database stored in a memory, wherein logging the new issue in the database comprises adding the new issue to an existing issue in response to the new issue corresponding to the existing issue, and logging the new issue in the database comprises generating a new issue entry in the database in response to the new issue failing to correspond to an existing issue; and
provide the new issue to a service provider for the service provider to resolve.

11. The apparatus of claim 10, wherein causing the apparatus to provide the new issue to a service provider for the service provider to resolve comprises causing the apparatus to:
provide an indication of the new issue identified;
provide the severity rating corresponding to the new issue; and
provide a virtual marker representing the location of the new issue on a map.

12. The apparatus of claim 10, wherein the at least one image in which the new issue is identified is received from a provider, wherein the apparatus is further caused to:
determine a reliability of the provider based on a determined accuracy of issues previously identified by the provider.

13. The apparatus of claim 10, wherein causing the apparatus to generate a severity rating corresponding to the new issue comprises causing the apparatus to identify risks associated with the new issue, wherein risks include one or more of: structural failure, electrical shock, trip hazard, or gas leak.

14. The apparatus of claim 10, wherein causing the apparatus to determine the location of the new issue comprises causing the apparatus to:
determine a location of an image capture device used to capture the at least one image in which the new issue is identified; and
determine an orientation of the image capture device used to capture the at least one image in which the new issue is identified.

15. The apparatus of claim 10, wherein the information relating to the new issue identified in the at least one image comprises a time and date of when the image was captured.

16. The apparatus of claim 10, wherein the new issue corresponds to the existing issue based, at least in part on the existing issue being located within a predefined distance of the location of the new issue and an issue type of the new issue corresponds with an issue type of the existing issue.

17. The apparatus of claim 16, wherein causing the apparatus to add the new issue to the existing issue comprises causing the apparatus to:
aggregate images corresponding to the existing issue; and
provide for display of an augmented reality of the existing issue based on the at least one image in which the new issue is identified and at least one image of the existing issue.

18. The apparatus of claim 10, wherein an issue type is determined from the image in which the new issue is identified based on processing the at least one image through a machine learning algorithm.

19. A computer program product comprising at least one non-transitory computer-readable storage medium having computer-executable program code portions stored therein, the computer-executable program code portions comprising program code instructions configured to:
receive at least one image in which a new issue is identified;
receive information relating to the new issue identified in the at least one image;
determine a location of the new issue;
identify any existing issues corresponding to the new issue;
generate a severity rating corresponding to the new issue;
log the new issue in a database stored in a memory, wherein logging the new issue in the database comprises adding the new issue to an existing issue in response to the new issue corresponding to the existing issue, and logging the new issue in the database comprises generating a new issue entry in the database in response to the new issue failing to correspond to an existing issue; and
provide the new issue to a service provider for the service provider to resolve.

20. The computer program product of claim 19, wherein the program code instructions to provide the new issue to a service provider for the service provider to resolve comprise program code instructions to:
provide an indication of the new issue identified;
provide the severity rating corresponding to the new issue; and
provide a virtual marker representing the location of the new issue on a map.
